(19) United States
(12) Patent Application Publication
(10) Pub. No.: US 2026/0105738 A1
(43) Pub. Date: Apr. 16, 2026

(54) A METHOD, AN APPARATUS AND A COMPUTER PROGRAM PRODUCT FOR IMAGE AND VIDEO PROCESSING

(71) Applicant: Nokia Technologies Oy, Espoo (FI)

(72) Inventors: Francesco CRICRÌ, Tampere (FI); Jani LAINEMA, Tampere (FI); Miska Matias HANNUKSELA, Tampere (FI); Honglei ZHANG, Tampere (FI); Ramin GHAZNAVI YOUVALARI, Tampere (FI); Maria Claudia SANTAMARIA GOMEZ, Tampere (FI); Ruiying YANG, Tampere (FI)

(21) Appl. No.: 19/117,324

(22) PCT Filed: Jul. 13, 2023
(86) PCT No.: PCT/EP2023/069471

§ 371 Date: Mar. 31, 2025

(30) Foreign Application Priority Data
Sep. 29, 2022 (FI) 20225858

(51) Int. Cl. G06V 10/82; G06V 10/72; G06V 10/74; G06V 20/40

(52) U.S. Cl. CPC G06V 10/82; G06V 10/72; G06V 10/761; G06V 20/40

(57) ABSTRACT

The embodiments relate to a method, comprising receiving an input; processing the input by the set of neural network based processors, wherein at least two neural network based processors in the set of neural network based processors generate an intermediate output; and combining, based at least on a set of values, at least two of the following to generate a final output; an intermediate output; one or more intermediate outputs; the input. The embodiments also relate to technical equipment for implementing the method.

The project leading to this application has received funding from the ECSEL Joint Undertaking (JU) under grant agreement No 876019. The JU receives support from the European Union's Horizon 2020 research and innovation programme and Germany, Netherlands, Austria, Romania, France, Sweden, Cyprus, Greece, Lithuania, Portugal, Italy, Finland, Turkey.

### TECHNICAL FIELD

The present solution generally relates to image and video processing.

### BACKGROUND

One of the elements in image and video compression is to compress data while maintaining the quality to satisfy human perceptual ability. However, in recent development of machine learning, machines can replace humans when analyzing data for example in order to detect events and/or objects in video/image. The present embodiments can be utilized in Video Coding for Machines, but also in other use cases.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided an apparatus comprising means for receiving an input; means for processing the input by the set of neural network based processors, wherein one or more neural network based processors in the set of neural network based processors generate respective one or more intermediate outputs; and means for combining, based at least on a set of values, at least two of the following to generate a final output: an intermediate output; one or more intermediate outputs; the input.

According to a second aspect, there is provided a method, comprising receiving an input; processing the input by the set of neural network based processors, wherein one or more neural network based processors in the set of neural network based processors generate respective one or more intermediate outputs; and combining, based at least on a set of values, at least two of the following to generate a final output: an intermediate output; one or more intermediate outputs; the input.

According to a third aspect, there is provided an apparatus comprising at least one processor, memory including computer program code, the memory and the computer program code configured to, with the at least one processor, cause the apparatus to perform at least the following: receive an input; process the input by the set of neural network based processors, wherein at least one or more neural network based processors in the set of neural network based processors generate respective one or more intermediate outputs; and combine, based at least on a set of values, at least two of the following to generate a final output: an intermediate output; one or more intermediate outputs; the input.

According to a fourth aspect, there is provided computer program product comprising computer program code configured to, when executed on at least one processor, cause an apparatus or a system to: receive an input; process the input by the set of neural network based processors, wherein one or more neural network based processors in the set of neural network based processors generate respective one or more intermediate outputs; and combine, based at least on a set of values, at least two of the following to generate a final output: an intermediate output; one or more intermediate outputs; the input.

According to an embodiment, the one or more intermediate outputs are output provided by one neural network based processor.

According to an embodiment, a first intermediate output is an output provided by the neural network based processor as a response to an input in its original form, and wherein any one or more of subsequent intermediate outputs is an output provided by the neural network based processor as a modified response to a modified input, where the modified input is obtained based on a modification operation applied to an input in its original form, and where the modified response is obtained based on an inverse modification operation applied to the output of the neural network based processor.

According to an embodiment, an input is modified by flipping the input data in horizontal direction, in vertical direction or in both directions, to obtain a flipped input, applying the neural network based processor to the flipped input to obtain an output, flipping back the output to obtain an intermediate output.

According to an embodiment, an intermediate output from two or more intermediate outputs is selected based at least on a selection flag, where the selection flag is provided in one of the following ways: signaled from an encoder to a decoder; is predefined for a decoder; is determined at a decoder side.

According to an embodiment, a similarity score is determined based at least on the first intermediate output and on the one or more subsequent intermediate outputs.

According to an embodiment, the neural network based processors comprise one or more components, whereupon internal data provided by said one or more components is used to generate the intermediate output.

According to an embodiment, a neural network based processor comprises one or more components, wherein the apparatus further comprises means for removing or modifying different sets of connections between the components to obtain two or more versions of the neural network based processor.

According to an embodiment, one or more intermediate outputs are weighted based at least on the set of values, where the set of values are determined based on one or more of the following: an indication for a set of predetermined weights, signaled from an encoder to a decoder; a weight update signaled from an encoder to a decoder; a set of weights, signaled from an encoder to a decoder; a set of weights, determined at decoder side.

According to an embodiment, an indication is received of whether the combining should use predetermined weights, or signaled weights, or signaled weight updates, or weights determined at decoder side as a set of values.

According to an embodiment, at least one of the values in the set of values is determined based on the similarity score between more than one intermediate output.

According to an embodiment, the information concerning processing of the input by the set of neural network based processors is determined, where the information comprises a processing order value for any of the neural network based processors; an identifier value of any of the neural network based processors; a type value indicating an operation to be carried out by any of the neural network based processors.

According to an embodiment, the computer program product is embodied on a non-transitory computer readable medium.

### DESCRIPTION OF THE DRAWINGS

In the following, various embodiments will be described in more detail with reference to the appended drawings, in which

FIG. 1 shows an example of a codec with neural network (NN) components;

FIG. 2 shows another example of a video coding system with neural network components;

FIG. 3 shows an example of a neural network-based end-to-end learned codec;

FIG. 4 shows an example of a neural network-based end-to-end learned video coding system;

FIG. 5 shows an example of a video coding for machines;

FIG. 6 shows an example of a pipeline for end-to-end learned system for video coding for machines;

FIG. 7 shows an example of training an end-to-end learned codec;

FIG. 8 shows an embodiment of combining a plurality of outputs;

FIG. 9 shows an embodiment of combining flipped data;

FIG. 10 shows an embodiment of combining flipped data and other data;

FIG. 11 shows an embodiment of combining intermediate data;

FIG. 12 is a flowchart illustrating a method according to an embodiment;

FIG. 13 shows an apparatus according to an embodiment.

### DESCRIPTION OF EXAMPLE EMBODIMENTS

The following description and drawings are illustrative and are not to be construed as unnecessarily limiting. The specific details are provided for a thorough understanding of the disclosure. However, in certain instances, well-known or conventional details are not described in order to avoid obscuring the description. References to one or an embodiment in the present disclosure can be, but not necessarily are, reference to the same embodiment and such references mean at least one of the embodiments.

Reference in this specification to “one embodiment” or “an embodiment” means that a particular feature, structure, or characteristic described in connection with the embodiment is included in at least one embodiment of the disclosure.

Before discussing the present embodiments in more detailed manner, a short reference to related technology is given.

In the context of machine learning, a neural network (NN) is a computation graph consisting of several layers of computation, i.e. several portions of computation. Each layer consists of one or more units, where each unit performs an elementary computation. A unit is connected to one or more other units, and the connection may have associated with a weight. The weight may be used for scaling the signal passing through the associated connection. Weights are learnable parameters, i.e., values which can be learned from training data. There may be other learnable parameters, such as those of batch-normalization layers.

Two widely used architectures for neural networks are feed-forward and recurrent architectures. Feed-forward neural networks are such that there is no feedback loop: each layer takes input from one or more of the layers before and provides its output as the input for one or more of the subsequent layers. Also, units inside a certain layer take input from units in one or more of preceding layers and provide output to one or more of following layers.

Initial layers (those close to the input data) extract semantically low-level features such as edges and textures in images, and intermediate and final layers extract more high-level features. After the feature extraction layers there may be one or more layers performing a certain task, such as classification, semantic segmentation, object detection, denoising, style transfer, super-resolution, etc. In recurrent neural nets, there is a feedback loop, so that the network becomes stateful, i.e., it is able to memorize information or a state.

Neural networks are being utilized in an ever-increasing number of applications for many different types of devices, such as mobile phones. Examples include image and video analysis and processing, social media data analysis, device usage data analysis, etc.

One of the important properties of neural networks (and other machine learning tools) is that they are able to learn properties from input data, either in supervised way or in unsupervised way. Such learning is a result of a training algorithm, or of a meta-level neural network providing the training signal.

In general, the training algorithm consists of changing some properties of the neural network so that its output is as close as possible to a desired output. For example, in the case of classification of objects in images, the output of the neural network can be used to derive a class or category index which indicates the class or category that the object in the input image belongs to. Training usually happens by minimizing or decreasing the output's error, also referred to as the loss. Examples of losses are mean squared error, cross-entropy, etc. In recent deep learning techniques, training is an iterative process, where at each iteration the algorithm modifies the weights of the neural net to make a gradual improvement of the network's output, i.e., to gradually decrease the loss.

In this description, terms “model” and “neural network” are used interchangeably, and also the weights of neural networks are sometimes referred to as learnable parameters or simply as parameters.

Training a neural network is an optimization process. The goal of the optimization or training process is to make the model learn the properties of the data distribution from a limited training dataset. In other words, the goal is to learn to use a limited training dataset in order to learn to generalize to previously unseen data, i.e., data which was not used for training the model. This is usually referred to as generalization. In practice, data may be split into at least two sets, the training set and the validation set. The training set is used for training the network, i.e., to modify its learnable parameters in order to minimize the loss. The validation set is used for checking the performance of the network on data, which was not used to minimize the loss, as an indication of the final performance of the model. In particular, the errors on the training set and on the validation set are monitored during the training process to understand the following things:
If the network is learning at all—in this case, the training set error should decrease, otherwise the model is in the regime of underfitting.
If the network is learning to generalize—in this case, also the validation set error needs to decrease and to be not too much higher than the training set error. If the training set error is low, but the validation set error is much higher than the training set error, or it does not decrease, or it even increases, the model is in the regime of overfitting. This means that the model has just memorized the training set's properties and performs well only on that set but performs poorly on a set not used for tuning its parameters.

As used herein, “overfitting” refers to processes by which a neural network is trained so that the network performs well for a specific content. In other words, a neural network can be overfitted for a particular image (a training set) such that the accuracy of the neural network for the particular image is higher than for images new to the neural network (a test set).

Lately, neural networks have been used for compressing and de-compressing data such as images, i.e., in an image codec. The most widely used architecture for realizing one component of an image codec is the auto-encoder, which is a neural network consisting of two parts: a neural encoder and a neural decoder. The neural encoder takes as input an image and produces a code which requires less bits than the input image. This code may be obtained by applying a binarization or quantization process to the output of the encoder. The neural decoder takes in this code and reconstructs the image which was input to the neural encoder.

Such neural encoder and neural decoder may be trained to minimize a combination of bitrate and distortion, where the distortion may be based on one or more of the following metrics: Mean Squared Error (MSE), Peak Signal-to-Noise Ratio (PSNR), Structural Similarity Index Measure (SSIM), or similar. These distortion metrics are meant to be correlated to the human visual perception quality, so that minimizing or maximizing one or more of these distortion metrics results into improving the visual quality of the decoded image as perceived by humans.

Video codec comprises an encoder that transforms the input video into a compressed representation suited for storage/transmission and a decoder that can decompress the compressed video representation back into a viewable form. An encoder may discard some information in the original video sequence in order to represent the video in a more compact form (that is, at lower bitrate).

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). Extensions of the H.264/AVC include Scalable Video Coding (SVC) and Multiview Video Coding (MVC).

The High Efficiency Video Coding (H.265/HEVC a.k.a. HEVC) standard was developed by the Joint Collaborative Team-Video Coding (JCT-VC) of VCEG and MPEG. The standard was published by both parent standardization organizations, and it is referred to as ITU-T Recommendation H.265 and ISO/IEC International Standard 23008-2, also known as MPEG-H Part 2 High Efficiency Video Coding (HEVC). Later versions of H.265/HEVC included scalable, multiview, fidelity range, three-dimensional, and screen content coding extensions which may be abbreviated SHVC, MV-HEVC, REXT, 3D-HEVC, and SCC, respectively.

Versatile Video Coding (H.266 a.k.a. VVC), defined in ITU-T Recommendation H.266 and equivalently in ISO/IEC 23090-3, (also referred to as MPEG-I Part 3) is a video compression standard developed as the successor to HEVC. A reference software for VVC is the VVC Test Model (VTM).

A specification of the AV1 bitstream format and decoding process were developed by the Alliance for Open Media (AOM). The AV1 specification was published in 2018. AOM is reportedly working on the AV2 specification.

An elementary unit for the input to a video encoder and the output of a video decoder, respectively, in most cases is a picture. A picture given as an input to an encoder may also be referred to as a source picture, and a picture decoded by a decoder may be referred to as a decoded picture or a reconstructed picture.

The source and decoded pictures are each comprises of one or more sample arrays, such as one of the following sets of sample arrays:
Luma (Y) only (monochrome),
Luma and two chroma (YCbCr or YCgCo),
Green, Blue and Red (GBR, also known as RGB),
Arrays representing other unspecified monochrome or tri-stimulus color samplings (for example, YZX, also known as XYZ).

A component may be defined as an array or single sample from one of the three sample arrays (luma and two chroma) that compose a picture, or the array or a single sample of the array that compose a picture in monochrome format.

Hybrid video codecs, for example ITU-T H.263 and H.264, may encode the video information in two phases. Firstly, pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e., the difference between the predicted block of pixels and the original block of pixels, is coded. This may be done by transforming the difference in pixel values using a specified transform (e.g., Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

Inter prediction, which may also be referred to as temporal prediction, motion compensation, or motion-compensated prediction, exploits temporal redundancy. In inter prediction the sources of prediction are previously decoded pictures.

Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means, the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

In video codecs, the motion information may be indicated with motion vectors associated with each motion compensated image block. Each of these motion vectors represents the displacement of the image block in the picture to be coded (in the encoder side) or decoded (in the decoder side) and the prediction source block in one of the previously coded or decoded pictures. In order to represent motion vectors efficiently, those may be coded differentially with respect to block specific predicted motion vectors. In video codecs, the predicted motion vectors may be created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index is typically predicted from adjacent blocks and/or or co-located blocks in temporal reference picture. Moreover, high efficiency video codecs can employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information may be carried out using the motion field information of adjacent blocks and/or co-located blocks in temporal reference pictures and the used motion field information is signaled among a list of motion field candidate list filled with motion field information of available adjacent/co-located blocks.

In video codecs the prediction residual after motion compensation may be first transformed with a transform kernel (like DCT) and then coded. The reason for this is that often there still exists some correlation among the residual and transform can in many cases help reduce this correlation and provide more efficient coding.

Video encoders may utilize Lagrangian cost functions to find optimal coding modes, e.g., the desired coding mode for a block, block partitioning, and associated motion vectors. This kind of cost function uses a weighting factor λ to tie together the (exact or estimated) image distortion due to lossy coding methods and the (exact or estimated) amount of information that is required to represent the pixel values in an image area:

$$C = D + λ R$$

where C is the Lagrangian cost to be minimized, D is the image distortion (e.g., Mean Squared Error) with the mode and motion vectors considered, and R the number of bits needed to represent the required data to reconstruct the image block in the decoder (including the amount of data to represent the candidate motion vectors). The rate R may be the actual bitrate or bit count resulting from encoding. Alternatively, the rate R may be an estimated bitrate or bit count. One possible way of the estimating the rate R is to omit the final entropy encoding step and use e.g., a simpler entropy encoding or an entropy encoder where some of the context states have not been updated according to previously encoding mode selections.

Conventionally used distortion metrics may comprise, but are not limited to, peak signal-to-noise ratio (PSNR), mean squared error (MSE), sum of absolute differences (SAD), sum of absolute transformed differences (SATD), and structural similarity (SSIM), typically measured between the reconstructed video/image signal (that is or would be identical to the decoded video/image signal) and the “original” video/image signal provided as input for encoding.

A partitioning may be defined as a division of a set into subsets such that each element of the set is in exactly one of the subsets.

A bitstream may be defined as a sequence of bits, which may in some coding formats or standards be in the form of a network abstraction layer (NAL) unit stream or a byte stream, that forms the representation of coded pictures and associated data forming one or more coded video sequences.

A bitstream format may comprise a sequence of syntax structures.

A syntax element may be defined as an element of data represented in the bitstream. A syntax structure may be defined as zero or more syntax elements present together in the bitstream in a specified order.

In some coding formats or standards, a bitstream may be in the form of a network abstraction layer (NAL) unit stream or a byte stream, that forms the representation of coded pictures and associated data forming one or more coded video sequences.

A NAL unit may be defined as a syntax structure containing an indication of the type of data to follow and bytes containing that data in the form of an RBSP interspersed as necessary with start code emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

In some coding formats, such as AV1, a bitstream may comprise a sequence of open bitstream units (OBUs). An OBU comprises a header and a payload, wherein the header identifies a type of the OBU. Furthermore, the header may comprise a size of the payload in bytes.

Some coding formats specify parameter sets that may carry parameter values needed for the decoding or reconstruction of decoded pictures. A parameter may be defined as a syntax element of a parameter set. A parameter set may be defined as a syntax structure that contains parameters and that can be referred to from or activated by another syntax structure for example using an identifier.

A coding standard or specification may specify several types of parameter sets. It needs to be understood that embodiments may be applied but are not limited to the described types of parameter sets and embodiments could likewise be applied to any parameter set type.

A parameter set may be activated when it is referenced e.g., through its identifier. An adaptation parameter set (APS) may be defined as a syntax structure that applies to zero or more slices. There may be different types of adaptation parameter sets. An adaptation parameter set may for example contain filtering parameters for a particular type of a filter. In VVC, three types of APSs are specified carrying parameters for one of: adaptive loop filter (ALF), luma mapping with chroma scaling (LMCS), and scaling lists. A scaling list may be defined as a list that associates each frequency index with a scale factor for the scaling process, which multiplies transform coefficient levels by a scaling factor, resulting in transform coefficients. In VVC, an APS is referenced through its type (e.g., ALF, LMCS, or scaling list) and an identifier. In other words, different types of APSs have their own identifier value ranges.

An Adaptation Parameter Set (APS) may comprise parameters for decoding processes of different types, such as adaptive loop filtering or luma mapping with chroma scaling.

Video coding specifications may enable the use of supplemental enhancement information (SEI) messages or alike. Some video coding specifications include SEI network abstraction layer (NAL) units, and some video coding specifications contain both prefix SEI NAL units and suffix SEI NAL units, where the former type can start a picture unit or alike and the latter type can end a picture unit or alike. An SEI NAL unit contains one or more SEI messages, which are not required for the decoding of output pictures but may assist in related processes, such as picture output timing, post-processing of decoded pictures, rendering, error detection, error concealment, and resource reservation. Several SEI messages are specified in H.264/AVC, H.265/HEVC, H.266/VVC, and H.274/VSEI standards, and the user data SEI messages enable organizations and companies to specify SEI messages for their own use. The standards may contain the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified. SEI messages are generally not extended in future amendments or versions of the standard.

Some video coding specifications enable metadata OBUs. A metadata OBU comprises a type field, which specifies the type of metadata.

The SEI prefix indication SEI message has been specified, for example, in HEVC and WVC. The SEI prefix indication SEI message carries one or more SEI prefix indications for SEI messages of a particular value of SEI payload type (payloadType). Each SEI prefix indication is a bit string that follows the SEI payload syntax of that value of payloadType and contains a number of complete syntax elements starting from the first syntax element in the SEI payload.

Each SEI prefix indication for an SEI message of a particular value of payloadType indicates that one or more SEI messages of this value of payloadType are expected or likely to be present in the coded video sequence (CVS) and to start with the provided bit string. A starting bit string would typically contain only a true subset of an SEI payload of the type of SEI message indicated by the payloadType and may contain a complete SEI payload.

SEI prefix indications should provide sufficient information for indicating what type of processing is needed or what type of content is included. The former (type of processing) indicates decoder-side processing capability, e.g., whether some type of frame unpacking is needed. The latter (type of content) indicates, for example, whether the bitstream contains subtitle captions in a particular language.

The SEI processing order SEI message has been described in document JVET-AA2027. The SEI processing order SEI message carries information indicating the preferred processing order, as determined by the encoder (i.e., the content producer), for different types of SEI messages that may be present in the bitstream. When an SEI processing order SEI message is present, it is present in the first access unit of the coded video sequence (CVS). The SEI processing order SEI message persists in decoding order from the current access unit until the end of the CVS. The SEI processing order SEI message comprises a list of pairs, each pair comprising a SEI payload type value po_sei_payload_type[i] and a processing order value po_sei_processing_order[i]. po_sei_payload_type[i] specifies the value of payloadType for the i-th SEI message for which information is provided in the SEI processing order SEI message. po_sei_processing_order[i] indicates the preferred order of processing any SEI message with payloadType equal to po_sei_payload_type[i]. po_sei_processing_order[m] greater than 0 and less than po_sei_processing_order[n] indicates any SEI message with payloadType equal to po_sei_payload_type[m], when present, should be processed before any SEI message with payloadType equal to po_sei_payload_type[n], when present. po_sei_processing_order[m] greater than 0 and equal to po_sei_processing_order[n] indicates that the preferred order of processing of SEI messages with payloadTypes equal to po_sei_payload_type[m] and po_sei_payload_type[n] is unknown or unspecified or determined by external means not specified in this Specification. po_sei_processing_order[i] equal to 0 specifies that the preferred order of processing SEI messages with payloadType equal to po_sei_payload_type[i] is unknown or unspecified or determined by external means.

The neural-network post-filter characteristics (NNPFC) SEI message and the neural-network post-filter activation (NNPFA) SEI message have been described in document JVET-AA2006. The NNPFC SEI message comprises the nnpfc_id syntax element, which contains an identifying number that may be used to identify a post-processing filter. A base post-processing filter is the filter that is contained in or identified by the first NNPFC SEI message, in decoding order, that has a particular nnpfc_id value within a coded layer video sequence (CLVS). If there is another NNPFC SEI message that has the same nnpfc_id value and different content than the NNPFC SEI message that defines the base post-processing filter, the base post-processing filter is updated by decoding the coded neural network bitstream in that NNPFC SEI message to obtain a post-processing filter associated with the nnpfc_id value. Otherwise, the post-processing processing filter associated with the nnpfc_id value is assigned to be the same as the base post-processing filter. The NNPFA SEI message specifies the neural-network post-processing filter that may be used for post-processing filtering for the current picture. The NNPFA SEI message comprises the nnpfa_id syntax element, which specifies that the neural-network post-processing filter with nnpfc_id equal to nnfpa_id may be used for post-processing filtering for the current picture.

The phrase along the bitstream (e.g., indicating along the bitstream) or along a coded unit of a bitstream (e.g., indicating along a coded tile) may be used in claims and described embodiments to refer to transmission, signaling, or storage in a manner that the “out-of-band” data is associated with but not included within the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively. For example, the phrase along the bitstream may be used when the bitstream is contained in a container file, such as a file conforming to the ISO Base Media File Format, and certain file metadata is stored in the file in a manner that associates the metadata to the bitstream, such as boxes in the sample entry for a track containing the bitstream, a sample group for the track containing the bitstream, or a timed metadata track associated with the track containing the bitstream.

Image and video codecs may use a set of filters to enhance the visual quality of the predicted visual content and can be applied either in-loop or out-of-loop, or both. In the case of in-loop filters, the filter applied on one block in the currently-encoded frame will affect the encoding of another block in the same frame and/or in another frame which is predicted from the current frame. An in-loop filter can affect the bitrate and/or the visual quality. In fact, an enhanced block will cause a smaller residual (difference between original block and predicted-and-filtered block), thus requiring less bits to be encoded. An out-of-the loop filter will be applied on a frame after it has been reconstructed, the filtered visual content won't be as a source for prediction, and thus it may only impact the visual quality of the frames that are output by the decoder.

Recently, neural network (NNs) have been used in the context of image and video compression by following mainly two approaches.

In one approach, NNs are used to replace one or more of the components of a traditional codec such as VVC/H.266. Here, term “traditional” refers to those codecs whose components and their parameters may not be learned from data. Examples of such components are:
Additional in-loop filter, for example by having the NN as an additional in-loop filter with respect to the traditional loop filters.
Single in-loop filter, for example by having the NN replacing all traditional in-loop filters.
Intra-frame prediction.
Inter-frame prediction.
Transform and/or inverse transform.
Probability model for the arithmetic codec.
Etc.

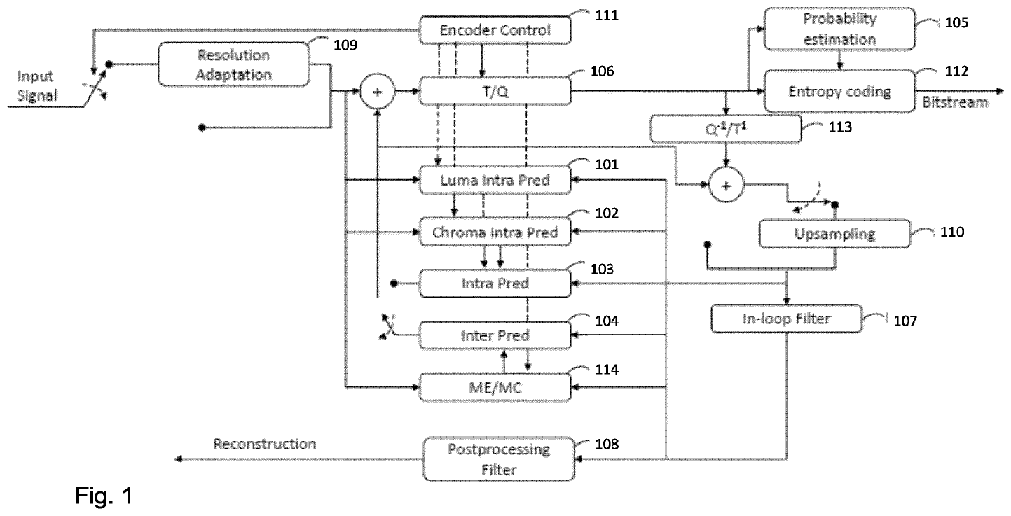

FIG. 1 illustrates examples of functioning of NNs as components of a traditional codec's pipeline, in accordance with an embodiment. In particular, FIG. 1 illustrates an encoder, which also includes a decoding loop. FIG. 1 is shown to include components described below:
A luma intra pred block or circuit 101. This block or circuit performs intra prediction in the luma domain, for example, by using already reconstructed data from the same frame. The operation of the luma intra pred block or circuit 101 may be performed by a deep neural network such as a convolutional auto-encoder.
A chroma intra pred block or circuit 102. This block or circuit performs intra prediction in the chroma domain, for example, by using already reconstructed data from the same frame. The chroma intra pred block or circuit 102 may perform cross-component prediction, for example, predicting chroma from luma. The operation of the chroma intra pred block or circuit 102 may be performed by a deep neural network such as a convolutional auto-encoder.
An intra pred block or circuit 103 and inter-pred block or circuit 104. These blocks or circuit perform intra prediction and inter-prediction, respectively. The intra pred block or circuit 103 and the inter-pred block or circuit 104 may perform the prediction on all components, for example, luma and chroma. The operations of the intra pred block or circuit 103 and inter-pred block or circuit 104 may be performed by two or more deep neural networks such as convolutional auto-encoders.
A probability estimation block or circuit 105 for entropy coding. This block or circuit performs prediction of probability for the next symbol to encode or decode, which is then provided to the entropy coding module 112, such as the arithmetic coding module, to encode or decode the next symbol. The operation of the probability estimation block or circuit 105 may be performed by a neural network.
A transform and quantization (T/Q) block or circuit 106. These are actually two blocks or circuits. The transform and quantization block or circuit 106 may perform a transform of input data to a different domain, for example, the FFT transform would transform the data to frequency domain. The transform and quantization block or circuit 106 may quantize its input values to a smaller set of possible values. In the decoding loop, there may be inverse quantization block or circuit and inverse transform block or circuit 113. One or both of the transform block or circuit and quantization block or circuit may be replaced by one or two or more neural networks. One or both of the inverse transform block or circuit and inverse quantization block or circuit 113 may be replaced by one or two or more neural networks.
An in-loop filter block or circuit 107. Operations of the in-loop filter block or circuit 107 is performed in the decoding loop, and it performs filtering on the output of the inverse transform block or circuit, or anyway on the reconstructed data, in order to enhance the reconstructed data with respect to one or more predetermined quality metrics. This filter may affect both the quality of the decoded data and the bitrate of the bitstream output by the encoder. The operation of the in-loop filter block or circuit 107 may be performed by a neural network, such as a convolutional auto-encoder. In examples, the operation of the in-loop filter may be performed by multiple steps or filters, where the one or more steps may be performed by neural networks.
A postprocessing filter block or circuit 108. The postprocessing filter block or circuit 108 may be performed only at decoder side, as it may not affect the encoding process. The postprocessing filter block or circuit 108 filters the reconstructed data output by the in-loop filter block or circuit 107, in order to enhance the reconstructed data. The postprocessing filter block or circuit 108 may be replaced by a neural network, such as a convolutional auto-encoder.
A resolution adaptation block or circuit 109: this block or circuit may downsample the input video frames, prior to encoding. Then, in the decoding loop, the reconstructed data may be upsampled, by the upsampling block or circuit 110, to the original resolution. The operation of the resolution adaptation block or circuit 109 block or circuit may be performed by a neural network such as a convolutional auto-encoder.
An encoder control block or circuit 111. This block or circuit performs optimization of encoder's parameters, such as what transform to use, what quantization parameters (QP) to use, what intra-prediction mode (out of N intra-prediction modes) to use, and the like. The operation of the encoder control block or circuit 111 may be performed by a neural network, such as a classifier convolutional network, or such as a regression convolutional network.
An ME/MC block or circuit 114 performs motion estimation and/or motion compensation, which are two key operations to be performed when performing inter-frame prediction. ME/MC stands for motion estimation/motion compensation.

In another approach, commonly referred to as “end-to-end learned compression”, NNs are used as the main components of the image/video codecs. In this second approach, there are two main options:

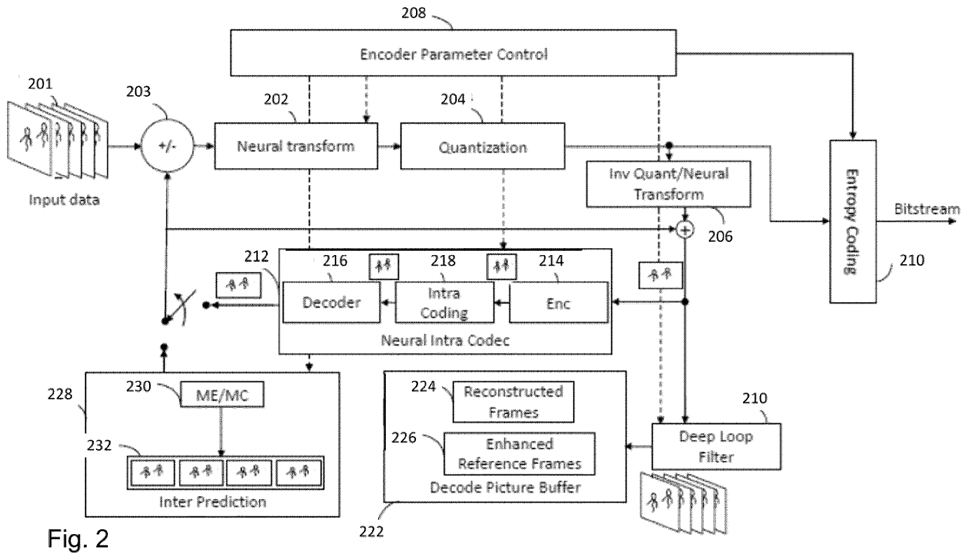

Option 1: re-use the video coding pipeline but replace most or all the components with NNs. Referring to FIG. 2, it illustrates an example of modified video coding pipeline based on a neural network, in accordance with an embodiment. An example of neural network may include, but is not limited to, a compressed representation of a neural network. FIG. 2 is shown to include following components:
A neural transform block or circuit 202: this block or circuit transforms the output of a summation/subtraction operation 203 to a new representation of that data, which may have lower entropy and thus be more compressible.
A quantization block or circuit 204: this block or circuit quantizes an input data 201 to a smaller set of possible values.
An inverse transform and inverse quantization blocks or circuits 206. These blocks or circuits perform the inverse or approximately inverse operation of the transform and the quantization, respectively.
An encoder parameter control block or circuit 208. This block or circuit may control and optimize some or all the parameters of the encoding process, such as parameters of one or more of the encoding blocks or circuits.
An entropy coding block or circuit 210. This block or circuit may perform lossless coding, for example based on entropy. One popular entropy coding technique is arithmetic coding.
A neural intra-codec block or circuit 212. This block or circuit may be an image compression and decompression block or circuit, which may be used to encode and decode an intra frame. An encoder 214 may be an encoder block or circuit, such as the neural encoder part of an auto-encoder neural network. A decoder 216 may be a decoder block or circuit, such as the neural decoder part of an auto-encoder neural network. An intra-coding block or circuit 218 may be a block or circuit performing some intermediate steps between encoder and decoder, such as quantization, entropy encoding, entropy decoding, and/or inverse quantization.
A deep loop filter block or circuit 220. This block or circuit performs filtering of reconstructed data, in order to enhance it.
A decode picture buffer block or circuit 222. This block or circuit is a memory buffer, keeping the decoded frame, for example, reconstructed frames 224 and enhanced reference frames 226 to be used for inter prediction.
An inter-prediction block or circuit 228. This block or circuit performs inter-frame prediction, for example, predicts from frames, for example, frames 232, which are temporally nearby. An ME/MC 230 performs motion estimation and/or motion compensation, which are two key operations to be performed when performing inter-frame prediction. ME/MC stands for motion estimation/motion compensation.

Option 2: re-design the whole pipeline, as follows.
Encoder NN is configured to perform a non-linear transform;
Quantization and lossless encoding of the encoder NN's output;
Lossless decoding and dequantization;
Decoder NN is configured to perform a non-linear inverse transform.

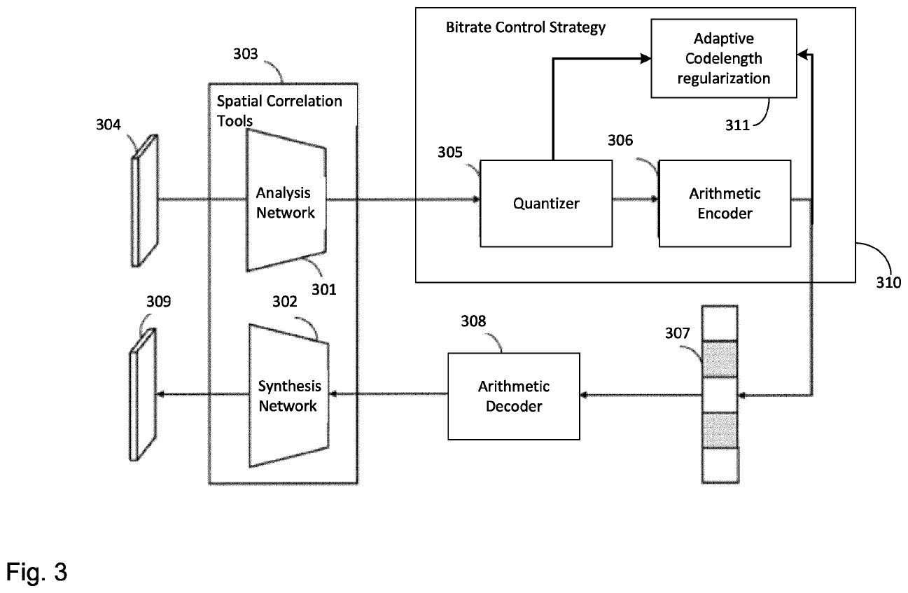

An example of option 2 is described in detail in FIG. 3 which shows an encoder NN and a decoder NN being parts of a neural auto-encoder architecture, in accordance with an example. In FIG. 3, the Analysis Network 301 is an Encoder NN, and the Synthesis Network 302 is the Decoder NN, which may together be referred to as spatial correlation tools 303, or as neural auto-encoder.

As shown in FIG. 3, the input data 304 is analyzed by the Encoder NN (Analysis Network 301), which outputs a new representation of that input data. The new representation may be more compressible. This new representation may then be quantized, by a quantizer 305, to a discrete number of values. The quantized data is then lossless encoded, for example by an arithmetic encoder 306, thus obtaining a bitstream 307. The example shown in FIG. 3 includes an arithmetic decoder 308 and an arithmetic encoder 306. The arithmetic encoder 306, or the arithmetic decoder 308, or the combination of the arithmetic encoder 306 and arithmetic decoder 308 may be referred to as arithmetic codec in some embodiments. On the decoding side, the bitstream is first lossless decoded, for example, by using the arithmetic codec decoder 308. The lossless decoded data is dequantized and then input to the Decoder NN, Synthesis Network 302. The output is the reconstructed or decoded data 309.

In case of lossy compression, the lossy steps may comprise the Encoder NN and/or the quantization.

In order to train this system, a training objective function (also called “training loss”) may be utilized, which may comprise one or more terms, or loss terms, or simply losses. In one example, the training loss comprises a reconstruction loss term and a rate loss term. The reconstruction loss encourages the system to decode data that is similar to the input data, according to some similarity metric. Examples of reconstruction losses are:
Mean squared error (MSE);
Multi-scale structural similarity (MS-SSIM);
Losses derived from the use of a pretrained neural network. For example, error(f1, f2), where f1 and f2 are the features extracted by a pretrained neural network for the input data and the decoded data, respectively, and error( ) is an error or distance function, such as L1 norm or L2 norm;
Losses derived from the use of a neural network that is trained simultaneously with the end-to-end learned codec. For example, adversarial loss can be used, which is the loss provided by a discriminator neural network that is trained adversarially with respect to the codec, following the settings proposed in the context of Generative Adversarial Networks (GANs) and their variants.

The rate loss encourages the system to compress the output of the encoding stage, such as the output of the arithmetic encoder. By “compressing”, we mean reducing the number of bits output by the encoding stage.

When an entropy-based lossless encoder is used, such as an arithmetic encoder, the rate loss typically encourages the output of the Encoder NN to have low entropy. Example of rate losses are the following:
A differentiable estimate of the entropy;
A sparsification loss, i.e., a loss that encourages the output of the Encoder NN or the output of the quantization to have many zeros. Examples are L0 norm, L1 norm, L1 norm divided by L2 norm;
A cross-entropy loss applied to the output of a probability model, where the probability model may be a NN used to estimate the probability of the next symbol to be encoded by an arithmetic encoder.

One or more of reconstruction losses may be used, and one or more of the rate losses may be used, as a weighted sum. The different loss terms may be weighted using different weights, and these weights determine how the final system performs in terms of rate-distortion loss. For example, if more weight is given to the reconstruction losses with respect to the rate losses, the system may learn to compress less but to reconstruct with higher accuracy (as measured by a metric that correlates with the reconstruction losses). These weights may be considered to be hyper-parameters of the training session and may be set manually by the person designing the training session, or automatically for example by grid search or by using additional neural networks.

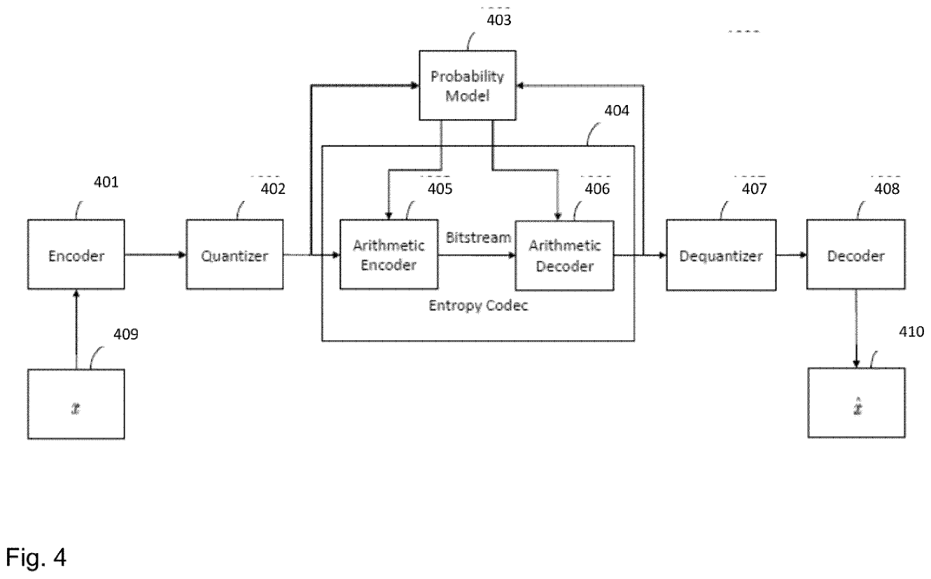

As shown in FIG. 4, a neural network-based end-to-end learned video coding system may contain an encoder 401, a quantizer 402, a probability model 403, an entropy codec 420 (for example arithmetic encoder 405/arithmetic decoder 406), a dequantizer 407, and a decoder 408. The encoder 401 and decoder 408 may be two neural networks, or mainly comprise neural network components. The probability model 403 may also comprise mainly neural network components. Quantizer 402, dequantizer 407 and entropy codec 420 may not be based on neural network components, but they may also comprise neural network components, potentially.

On the encoder side, the encoder component 401 takes a video x 409 as input and converts the video from its original signal space into a latent representation that may comprise a more compressible representation of the input. In the case of an input image, the latent representation may be a 3-dimensional tensor, where two dimensions represent the vertical and horizontal spatial dimensions, and the third dimension represent the “channels” which contain information at that specific location. If the input image is a 128×128×3 RGB image (with horizontal size of 128 pixels, vertical size of 128 pixels, and 3 channels for the Red, Green, Blue color components), and if the encoder downsamples the input tensor by 2 and expands the channel dimension to 32 channels, then the latent representation is a tensor of dimensions (or “shape”) 64×64×32 (i.e., with horizontal size of 64 elements, vertical size of 64 elements, and 32 channels). Please note that the order of the different dimensions may differ depending on the convention which is used; in some cases, for the input image, the channel dimension may be the first dimension, so for the above example, the shape of the input tensor may be represented as 3×128×128, instead of 128×128×3. In the case of an input video (instead of just an input image), another dimension in the input tensor may be used to represent temporal information.

The quantizer component 402 quantizes the latent representation into discrete values given a predefined set of quantization levels. Probability model 403 and arithmetic codec component 420 work together to perform lossless compression for the quantized latent representation and generate bitstreams to be sent to the decoder side. Given a symbol to be encoded into the bitstream, the probability model 403 estimates the probability distribution of all possible values for that symbol based on a context that is constructed from available information at the current encoding/decoding state, such as the data that has already been encoded/decoded. Then, the arithmetic encoder 405 encodes the input symbols to bitstream using the estimated probability distributions.

On the decoder side, opposite operations are performed. The arithmetic decoder 406 and the probability model 403 first decode symbols from the bitstream to recover the quantized latent representation. Then the dequantizer 407 reconstructs the latent representation in continuous values and pass it to decoder 408 to recover the input video/image. Note that the probability model 403 in this system is shared between the encoding and decoding systems. In practice, this means that a copy of the probability model 403 is used at encoder side, and another exact copy is used at decoder side.

In this system, the encoder 401, probability model 403, and decoder 408 may be based on deep neural networks. The system may be trained in an end-to-end manner by minimizing the following rate-distortion loss function:

L=D+λR,

where D is the distortion loss term, R is the rate loss term, and λ is the weight that controls the balance between the two losses. The distortion loss term may be the mean square error (MSE), structure similarity (SSIM) or other metrics that evaluate the quality of the reconstructed video. Multiple distortion losses may be used and integrated into D, such as a weighted sum of MSE and SSIM. The rate loss term is normally the estimated entropy of the quantized latent representation, which indicates the number of bits necessary to represent the encoded symbols, for example, bits-per-pixel (bpp).

For lossless video/image compression, the system may contain only the probability model 403 and arithmetic encoder/decoder 405, 406. The system loss function contains only the rate loss, since the distortion loss is always zero (i.e., no loss of information).

Reducing the distortion in image and video compression is often intended to increase human perceptual quality, as humans are considered to be the end users, i.e., consuming/watching the decoded image. Recently, with the advent of machine learning, especially deep learning, there is a rising number of machines (i.e., autonomous agents) that analyze data independently from humans and that may even take decisions based on the analysis results without human intervention. Examples of such analysis are object detection, scene classification, semantic segmentation, video event detection, anomaly detection, pedestrian tracking, etc. Example use cases and applications are self-driving cars, video surveillance cameras and public safety, smart sensor networks, smart TV and smart advertisement, person re-identification, smart traffic monitoring, drones, etc. When the decoded data is consumed by machines, a different quality metric shall be used instead of human perceptual quality. Also, dedicated algorithms for compressing and decompressing data for machine consumption are likely to be different than those for compressing and decompressing data for human consumption. The set of tools and concepts for compressing and decompressing data for machine consumption is referred to here as Video Coding for Machines (VCM).

VCM concerns the encoding of video streams to allow consumption for machines. Machine is referred to indicate any device except human. Example of machine can be a mobile phone, an autonomous vehicle, a robot, and such intelligent devices which may have a degree of autonomy or run an intelligent algorithm to process the decoded stream beyond reconstructing the original input stream.

A machine may perform one or multiple tasks on the decoded stream. Examples of tasks can comprise the following:
Classification: classify an image or video into one or more predefined categories. The output of a classification task may be a set of detected categories, also known as classes or labels. The output may also include the probability and confidence of each predefined category.
Object detection: detect one or more objects in a given image or video. The output of an object detection task may be the bounding boxes and the associated classes of the detected objects. The output may also include the probability and confidence of each detected object.
Instance segmentation: identify one or more objects in an image or video at the pixel level. The output of an instance segmentation task may be binary mask images or other representations of the binary mask images, e.g., closed contours, of the detected objects. The output may also include the probability and confidence of each object for each pixel.
Semantic segmentation: assign the pixels in an image or video to one or more predefined semantic categories. The output of a semantic segmentation task may be binary mask images or other representations of the binary mask images, e.g., closed contours, of the assigned categories. The output may also include the probability and confidence of each semantic category for each pixel.
Object tracking: track one or more objects in a video sequence. The output of an object tracking task may include frame index, object ID, object bounding boxes, probability, and confidence for each tracked object.
Captioning: generate one or more short text descriptions for an input image or video. The output of the captioning task may be one or more short text sequences.
Human pose estimation: estimate the position of the key points, e.g., wrist, elbows, knees, etc., from one or more human bodies in an image of the video. The output of a human pose estimation includes sets of locations of each key point of a human body detected in the input image or video.
Human action recognition: recognize the actions, e.g., walking, talking, shaking hands, of one or more people in an input image or video. The output of the human action recognition may be a set of predefined actions, probability, and confidence of each identified action.
Anomaly detection: detect abnormal object or event from an input image or video. The output of an anomaly detection may include the locations of detected abnormal objects or segments of frames where abnormal events detected in the input video.

It is likely that the receiver-side device has multiple “machines” or task neural networks (Task-NNs). These multiple machines may be used in a certain combination which is for example determined by an orchestrator sub-system. The multiple machines may be used for example in succession, based on the output of the previously used machine, and/or in parallel. For example, a video which was compressed and then decompressed may be analyzed by one machine (NN) for detecting pedestrians, by another machine (another NN) for detecting cars, and by another machine (another NN) for estimating the depth of all the pixels in the frames.

In this description, “task machine” and “machine” and “task neural network” are referred to interchangeably, and for such referral any process or algorithm (learned or not from data) which analyzes or processes data for a certain task is meant. In the rest of the description, other assumptions made regarding the machines considered in this disclosure may be specified in further details. Also, term “receiver-side” or “decoder-side” are used to refer to the physical or abstract entity or device, which contains one or more machines, and runs these one or more machines on an encoded and eventually decoded video representation which is encoded by another physical or abstract entity or device, the “encoder-side device”.

The encoded video data may be stored into a memory device, for example as a file. The stored file may later be provided to another device. Alternatively, the encoded video data may be streamed from one device to another.

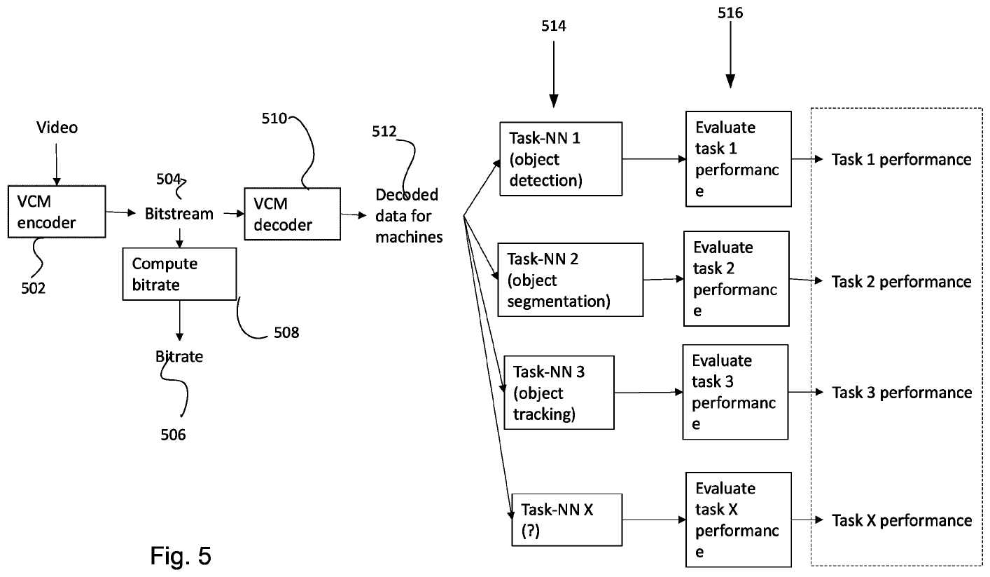

FIG. 5 is a general illustration of the pipeline of Video Coding for Machines. A VCM encoder 502 encodes the input video into a bitstream 504. A bitrate 506 may be computed 508 from the bitstream 504 in order to evaluate the size of the bitstream. A VCM decoder 510 decodes the bitstream output by the VCM encoder 502. In FIG. 5, the output of the VCM decoder 510 is referred to as “Decoded data for machines” 512. This data may be considered as the decoded or reconstructed video. However, in some implementations of this pipeline, this data may not have same or similar characteristics as the original video which was input to the VCM encoder 502. For example, this data may not be easily understandable by a human when rendering the data onto a screen. The output of VCM decoder is then input to one or more task neural networks 514. In the figure, for the sake of illustrating that there may be any number of task-NNs 514, there are three example task-NNs, and a non-specified one (Task-NN X). The goal of VCM is to obtain a low bitrate representation of the input video while guaranteeing that the task-NNs still perform well in terms of the evaluation metric 516 associated to each task.

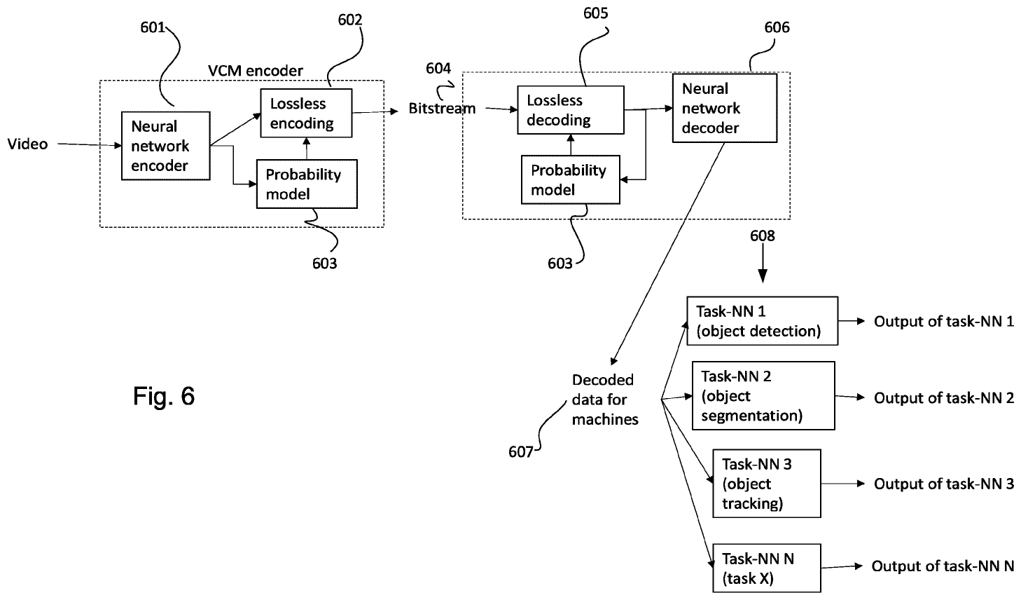

One of the possible approaches to realize video coding for machines is an end-to-end learned approach. In this approach, the VCM encoder and VCM decoder mainly consist of neural networks. FIG. 6 illustrates an example of a pipeline for the end-to-end learned approach. The video is input to a neural network encoder 601. The output of the neural network encoder 601 is input to a lossless encoder 602, such as an arithmetic encoder, which outputs a bitstream 604. The output of the neural network encoder 601 may be input also to a probability model 603 which provides to the lossless encoder 602 with an estimate of the probability of the next symbol to be encoded by the lossless encoder 602. The probability model 603 may be learned by means of machine learning techniques, for example it may be a neural network. At decoder-side, the bitstream 604 is input to a lossless decoder 605, such as an arithmetic decoder, whose output is input to a neural network decoder 606. The output of the lossless decoder 605 may be input to a probability model 603, which provides the lossless decoder 605 with an estimate of the probability of the next symbol to be decoded by the lossless decoder 605. The output of the neural network decoder 606 is the decoded data for machines 607, that may be input to one or more task-NNs 608.

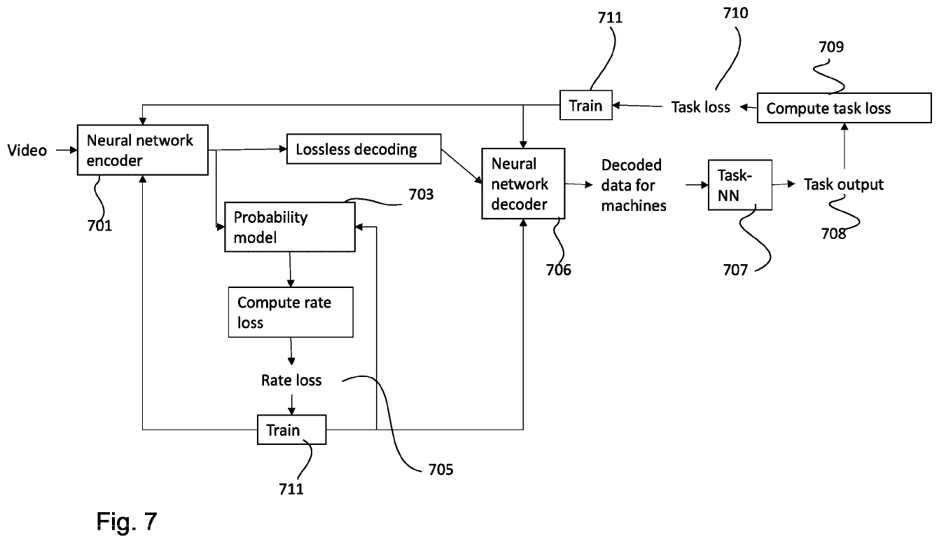

FIG. 7 illustrates an example of how the end-to-end learned system may be trained for the purpose of video coding for machines. For the sake of simplicity, only one task-NN 707 is illustrated. A rate loss 705 may be computed from the output of the probability model 703. The rate loss 705 provides an approximation of the bitrate required to encode the input video data. A task loss 710 may be computed 709 from the output 708 of the task-NN 707.

The rate loss 705 and the task loss 710 may then be used to train 711 the neural networks used in the system, such as the neural network encoder 701, the probability model 703, the neural network decoder 706. Training may be performed by first computing gradients of each loss with respect to the trainable neural networks' parameters that are contributing or affecting the computation of that loss. The gradients are then used by an optimization method, such as Adam, for updating the trainable parameters of the neural networks.

The machine tasks may be performed at decoder side (instead of at encoder side) for multiple reasons, for example because the encoder-side device does not have the capabilities (computational, power, memory) for running the neural networks that perform these tasks, or because some aspects or the performance of the task neural networks may have changed or improved by the time that the decoder-side device needs the tasks results (e.g., different or additional semantic classes, better neural network architecture). Also, there could be a customization need, where different clients would run different neural networks for performing these machine learning tasks.

In some video codecs, a neural network may be used as a filter in the decoding loop, and it may be referred to as neural network loop filter, or neural network in-loop filter. The NN loop filter may replace one or more of the loop filters present in an existing video codec or may represent an additional loop filter with respect to the already present loop filters in an existing video codec. In the context of image and video enhancement, a neural network may be used as post-processing filter, for example applied to the output of an image or video decoder in order to remove or reduce coding artifacts.

A post-processing filter is taken as an example of a use case, where the task of the filter is to enhance the quality of an input video frame that has been decoded by a video decoder. The input data provided to a filter may include the frame to be filtered, and some additional data related to that frame or to the encoding or decoding process.

At least some of the present embodiments relate to neural networks used as part of the decoding operations (such as a NN loop filter, or an intra-frame prediction NN, or an inter-frame prediction NN) or as a part of post-processing operations (a NN post-processing filter). Also, at least some of the present embodiments relate to the signalling of information related to those NNs, where the information is signaled from an encoder to a decoder.

The following example system may be used in several embodiments to illustrate or describe the idea. The example system comprises a VVC/H.266 compliant codec and a post-processing NN (NN post-filter), where the NN post-filter is applied on at least an output of the decoder in order to enhance the quality of an output of the decoder (e.g., a decoded frame). Quality may be measured in terms of a metric that can include one or more of the following:
Mean-squared error (MSE);
Peak signal-to-noise ratio (PSNR);
Mean Average Precision (mAP) computed based at least on the output of a task NN (such as an object detection NN) when the input is the output of the post-processing NN;
Other task-related metrics, for tasks such as object tracking, video activity classification, video anomaly detection, etc.

The enhancement may result into a coding gain, which can be expressed for example in terms of BD-rate or BD-PSNR.

A decoder may have multiple NN filters available. For example, a decoder may have four pretrained filters and one filter that has been overfitted on some data. Also, it may be possible to obtain more than one version of filtered data from each NN filter, e.g., given a certain data item, it may be possible to obtain more than one output from the NN filter. In the present disclosure, the term “intermediate outputs” refers to one or more outputs from respective one or more filters and/or to the one or more versions of output that is possible to obtain from each filter. The present embodiments provide a solution by means of which it is possible to determine intermediate outputs and ways to combine the intermediate outputs to generate a final output.

According to an embodiment, the one or more outputs from the respective one or more filters and, optionally, also the input to the filters, may be combined by a set of weights, where the set of weights may be signaled from an encoder to a decoder or may be predetermined or may be determined at decoder side.

According to an embodiment, in order to obtain more than one output from a NN filter, i.e., the intermediate outputs, the filter may be run at least two times, where at a first time the input data may be provided to the filter in its original form (i.e., unmodified), obtaining a first intermediate output, and at a second time the input data may be modified by means of a first modification operation, obtaining a first modified output. The first modification operation may be required to have an associated first inverse modification operation. The first modified output may be further modified by a first inverse modification operation that is associated to the first modification operation, obtaining a second intermediate output. A similar procedure may be performed for obtaining a third intermediate output based at least on a second modification operation and an associated second inverse modification operation. The first intermediate output and the second intermediate output (and any other intermediate outputs, if any) may be combined by means of a combination operation.

In one embodiment, a modification operation comprises flipping an input data horizontally or vertically or both. In at least some of the embodiments described herein, flipping horizontally or vertically or both is considered as an example, but it is to be understood than other suitable modification operations may be considered instead. In an example where the modification operation comprises flipping horizontally, an intermediate output may be obtained by horizontally flipping the input data, running the filter on the horizontally flipped data, obtaining an output from the filter, horizontally flipping back the output. Flipping may also be referred to as reflection or mirroring.

According to an embodiment, the output of a NN filter is weighted based on a weight that is determined based on a similarity score, where the similarity score may be computed based on at least the following:
The first intermediate output, e.g., the output of the filter, when the input is the original input (no changes to the input). This is referred to as “original output”.
The second intermediate output, e.g., the flipped-back output of the filter, when the input is a flipped version of the original input; this is referred to as “flipped-back output”.

According to an embodiment, in order to obtain more than one output from a NN filter, more than one version of the NN filter may be obtained by removing or modifying different sets of connections between layers of the NN filter.

These and other embodiments are discussed in the following in more detailed manner.

In at least some of the embodiments, compressing and decompressing data is performed by using a codec. The data, in at least some of the embodiments, is video. However, the embodiments can be applied to other types of data as well. Examples of such data types are images, audio, etc.

An encoder-side device performs a compression or encoding operation of an input video by using a video encoder. The output of the video encoder is a bitstream representing the compressed video. A decoder-side device performs decompression or decoding operation of the compressed video by using a video decoder. The output of the video decoder may be referred to as decoded video, where the decoded video may comprise one or more frames or images. The decoded video may be post-processed by one or more post-processing operations, such as a post-processing filter. The output of the one or more post-processing operations may be referred to as post-processed video.

The encoder-side device may also include at least some decoding operations, for example in a coding loop, and/or at least some post-processing operations. In one example, the encoder may include all the decoding operations and any post-processing operations.

The encoder-side device and the decoder-side device may be the same physical device, or different physical devices.

The decoder or the decoder-side device may contain one or more neural networks. Some examples of such neural networks are the following:
A post-processing NN filter (also referred to here as post-filter, or NN post filter, or post-filter NN), which takes as input at least one of the outputs of an end-to-end learned decoder or of a conventional decoder (i.e., a decoder not comprising neural networks or other components learned from data) or of a hybrid decoder (i.e., a decoder comprising one or more neural networks or other components learned from data).
A NN in-loop filter (also referred to here as in-loop NN filter, or NN loop filter, or loop NN filter) used within an end-to-end learned decoder, or within a hybrid decoder.
A learned probability model (e.g., a NN) that is used for providing estimates of probabilities of symbols to be encoded and/or decoded by a lossless coding module, within an end-to-end learned codec or within a hybrid codec.
A decoder neural network for an end-to-end learned codec.
   Combining Data from Different Filters

In one embodiment, the intermediate outputs are two or more outputs from respective two or more filters. The intermediate outputs, and eventually also the input to the two or more filters, may be combined based on two or more weights.

In one embodiment, the two or more weights may be signaled from the encoder to the decoder. The encoder may signal directly the value of the two or more weights, eventually encoded by lossy and/or lossless compression, or the encoder may signal two or more indications for the values of the two or more weights, where the indications may comprise predetermined keys of a look-up table or dictionary; upon receiving the indications from the encoder, the decoder uses them for retrieving the respective weights from a look-up table.

In one embodiment, the two or more weights may be predetermined and already available to the decoder. In such case, the encoder may send to the decoder one or more adjustment signals, where the one or more adjustment signals may be used to adjust the weights (e.g., the adjustment signals may represent a weight-update).

In one embodiment, the two or more weights may be determined at decoder side. In one example, the two or more weights may be determined based at least on data decoded by a decoder and on a neural network.

The encoder may signal to the decoder an indication that indicates whether the combination shall use the predetermined weights and/or the signaled weights and/or the signaled weight-update and/or the weights determined at decoder side.

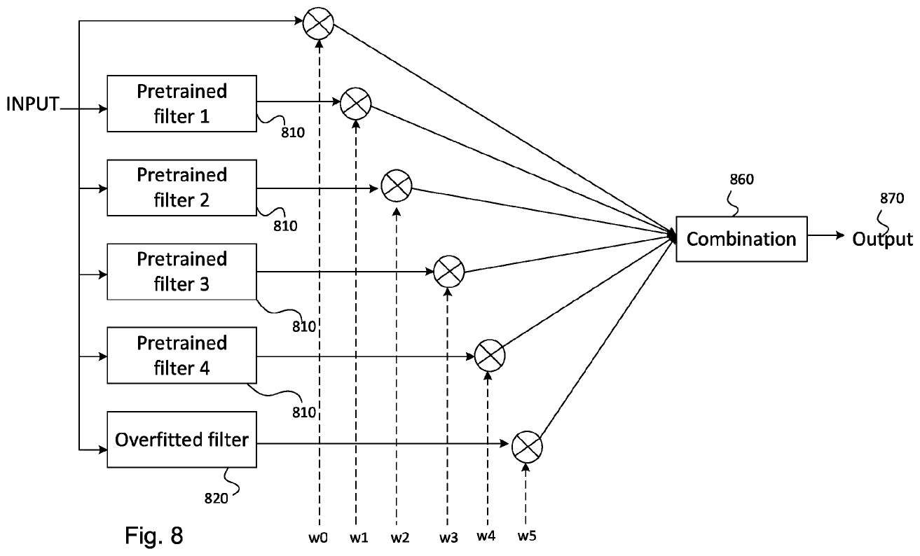

FIG. 8 illustrates an example, where the outputs of four pretrained filters 810, one overfitted filter 820 and the input to the filters 810, 820 are combined based at least on weights w0, w1, w2, w3, w4, w5, where the weights w0, w1, w2, w3, w4, w5 may be signaled from the encoder to the decoder or may be predetermined or may be determined at decoder side. Each of the weights w0, w1, w2, w3, w4, w5 may comprise one or more values. In one example, each of the weights w0, w1, w2, w3, w4, w5 may comprise one value that is used to multiply element-wise the associated intermediate data (e.g., the input to the filters, or the outputs of the pretrained filters 810, or the output of the overfitted filter 820). In another example, each of the weights w0, w1, w2, w3, w4, w5 may comprise three values that are used to multiply respective three channels of the associated intermediate data. The combination 860 may comprise a summation operation to generate a final output 870.

### Combining Flipped Data

According to this embodiment, in order to obtain two or more outputs from a NN filter 920, the input data may be flipped 910 horizontally or vertically. The output of the filter is then flipped back, obtaining an intermediate output that can then be combined with the output of the filter when no flipping of the input was performed. In one embodiment, an average or a weighted average may be performed as a combination, based at least on two weights. In another embodiment, the combination may comprise selecting either one of the two intermediate outputs, based at least on a selection flag. The two weights or the selection flag may be signaled from an encoder to a decoder, or may be predetermined, or may be determined at decoder side.

In this context, flipping refers to the operation by which the output of flipping is a mirror-reversal of the input of flipping on one of the horizontal or vertical axes. Horizontal flipping of an input image x can be computed as follows:

```
for(i=0; i<w; i++) {
  for(j=0; j<h; j++) {
    xflipped[i,j] = x[w−1−i,j]
  }
}
```

where w and h represent the width and height of the input image, respectively, xflipped represents the flipped version of x, and array indexing [hor,ver] is used for accessing xflipped and x, where hor indicates a horizontal coordinate and ver indicates a vertical coordinate.

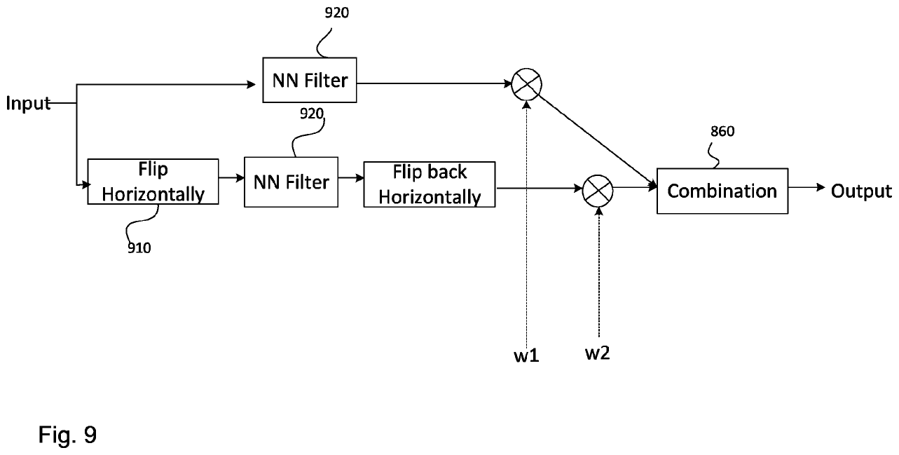

FIG. 9 shows an example where the input is flipped horizontally and given as input to the NN filter. The output of the filter is flipped back. The same NN filter is used to filter also the original input (notice that the two blocks “NN filter” represent the same filter). However, the filter that is used to filter the original input and the filter that is used to filter the flipped input may be different filters. A combination of the two intermediate outputs is performed based on two weights, which may be predetermined or may be signaled from encoder to decoder or may be determined at decoder side.

In one example, the encoder may decide to signal w1=0 and w2=1 (which correspond to selecting only one of the two outputs). In another example, it may signal w1=0.5, w2=0.5. When the signaled weights are such that only one of the two outputs is selected (i.e., one of the two weights is 1 and the other weights is 0, i.e., w1=0 and w2=1, or w1=1 and w2=0), the decoder may decide to perform an inference only for the case which was selected by the encoder. For example, if w1=0 and w2=1, only the flipped input will be provided as input to the NN filter. The output of the NN filter will be flipped back and the result will represent the final output of the filtering.

### Combining Flipped Data and Other Data

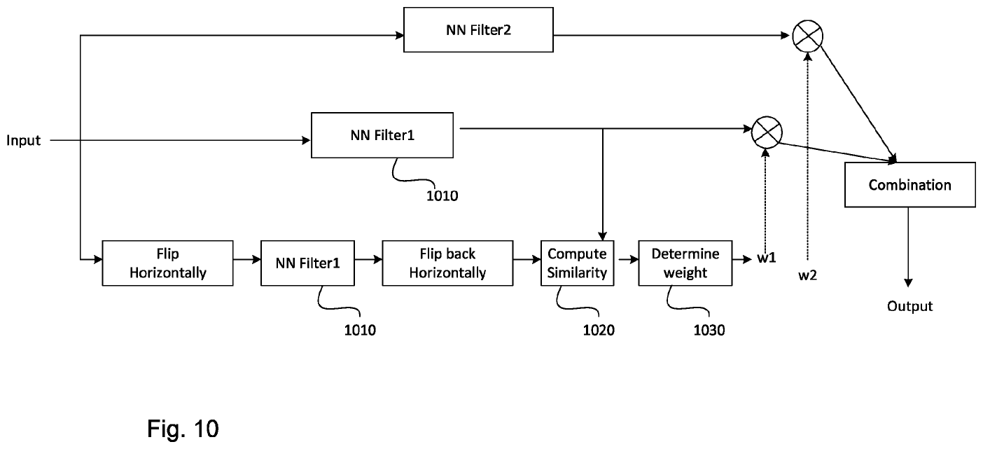

FIG. 10 shows an embodiment, where the output of at least one first filter 1010 is combined with one or more other data. The one or more other can comprise an output of a second filter and/or an input to one or more filters.

For the at least one first NN filter 1010, the output of that NN filter 1010 is combined with other data based on a weight that is determined 1030 based at least on a similarity score 1020, where the similarity score 1020 may be computed based at least on the following:
The output of the first filter 1010 when the input is the original input (no changes to the input). This is referred to as “original output”.
The flipped-back output of the first filter 1010 when the input is a flipped version of the original input. This is referred to as “flipped-back output”.

The similarity score 1020 between the original output and the flipped-back output may be computed for example based on MSE (e.g., PSNR). If the similarity is high, the output of the filter is considered to be reliable and the weight is set to a high value, otherwise the weight is set to a low value.

In one example, the weight can be either 1 or 0 and determined based at least on a predetermined or signaled threshold that is applied on the values of the similarity score. For example, if the similarity score is below 0.5, the weight is determined to be 0.

In another example, the weight is computed by normalizing the similarity score and using the normalized similarity as the weight. The normalization may comprise a scaling operation and/or a shifting operation.

Combining Data from Manipulated Models

According to an embodiment, in order to obtain two or more outputs from a NN filter, two or more versions of the NN filter may be obtained by removing or modifying different sets of connections between layers. This may be realized by performing two or more drop-out operations, which may comprise using drop-out layers in the NN filter architecture and running the NN filter multiple times. The drop-out layers may randomly drop some connection with a predefined probability (e.g., with probability 0.7).

An encoder may signal information about how to perform the drop-out operations, where such information may comprise one or more of the following:
How many times the NN filter needs to be run or executed (where, at each time, different connections are dropped).
The drop-out probability.
A pseudo-random number used by the drop-out layers.
   Combining Internal Data from Different Filters

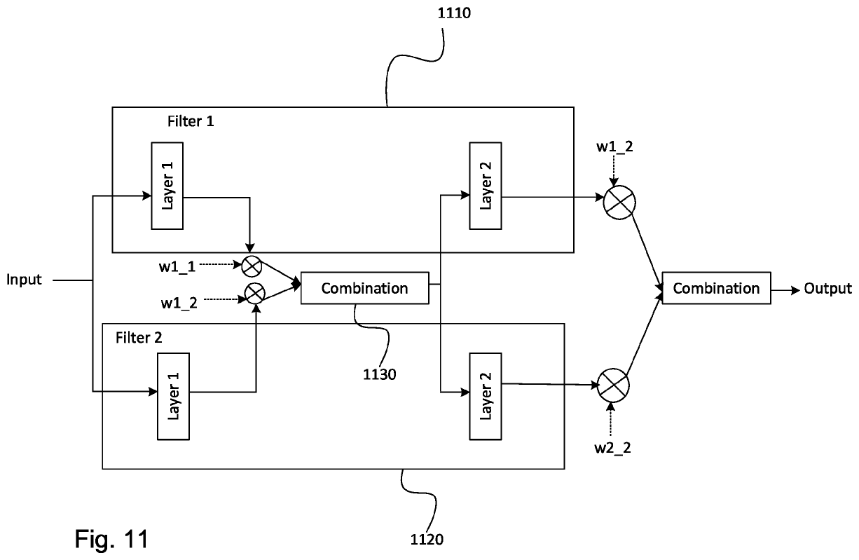

FIG. 11 illustrates an embodiment, where internal data from two or more filters is combined. For the sake of simplicity, two filters 1110, 1120 are considered, where the two filters 1110 and 1120 may have similar NN architecture but trained on different training data or based on different training procedures. According to an embodiment, internal data generated by one or more components of the two filters 1110, 1120 may be combined 1130 to generate one or more new internal data. The new internal data may be further processed by one or more components (e.g., Layer 2) of one or more or the two or more filters. The outputs of the filters 1110, 1120 may be combined to generate the final output. The combination procedure may be performed according to a method described in one or more previous embodiments. The weights used to combine the intermediate data may be predefined by the system or signaled from the encoder to the decoder or determined at decoder side. The selection of the intermediate data to be combined may be predefined or signaled from the encoder to the decoder or determined at decoder side.

### Embodiments for Signaling Processing Order

According to an embodiment, an encoder indicates in or along a bitstream, such as SEI message, a first processing order value for the first filter and a second processing order value for a second filter. According to an embodiment, a decoder decodes from or along a bitstream, such as from an SEI message, a first processing order value for a first filter and a second processing order value for a second filter. In both embodiments, when the first processing order value is equal to the second processing order value, the first and second filters use at least partially the same input signal. For example, the first and second filters may use as input the sample arrays resulting from the previous post-processing step in the processing order.

A first filter may be identified by a first identifier value and a second filter may be identified by a second identifier value. The identifier values may be included in a neural network post-filter characteristics SEI message or a like, which has a particular type value, such as an SEI message payload type.

According to an embodiment, an encoder includes a SEI prefix indication SEI message or alike in or along a bitstream, wherein the SEI prefix indication SEI message comprises the type value (e.g., the SEI message type of the NNPFC SEI message) and two prefixes of NNPFC SEI messages or alike, one containing the first identifier value and another containing the second identifier value. Furthermore, the encoder includes in a processing order indication, such as in a SEI processing order SEI message, sets of a type value (e.g., the SEI message type of the NNPFC SEI message), a processing order value, and an index value indicating the prefix included in the SEI prefix indication SEI message or alike. The processing order values associated with the prefixes that contain the first or second identifiers indicate the respective processing order of the first filter and the second filter. The po_sei_prefix_index[i] may be added to the syntax of the SEI processing order SEI message, e.g., as follows:

| | Descriptor |
|---|---|
| sei_processing_order( payloadSize ) { | |
| for( i = 0, b = 0; b < payloadSize; i++, b += 4 ) { | |
| po_sei_payload_type[ i ] | u(16) |
| po_sei_prefix_index[ i ] | u(8) |
| po_sei_processing_order[ i ] | u(8) |
| } | |
| } | |

The semantics of po_sei_prefix_index[i] may be specified as follows: po_sei_prefix_index[i] indicates, when there is an SEI prefix indication SEI message with prefix_sei_payload_type equal to po_sei_payload_type[i] present in the same CVS, that the processing order is indicated for the SEI message that has the po_sei_prefix_index[i]-th prefix indication in the SEI prefix indication SEI message. In this case, po_sei_processing_order[i] indicates the preferred order of processing the SEI message that has payloadType equal to po_sei_payload_type[i] and the po_sei_prefix_index[i]-th prefix indication in the SEI prefix indication SEI message. When there is no SEI prefix indication SEI message with prefix_sei_payload_type equal to po_sei_payload_type[i] present in the same CVS, it may be required that po_sei_prefix_index[i] is equal to a pre-defined value, such as 0, and may not bear semantics. In this case, po_sei_processing_order[i] indicates the preferred order of processing any SEI message with payloadType equal to po_sei_payload_type[i].

In an embodiment, a decoder decodes a SEI prefix indication SEI message or alike from or along a bitstream, wherein the SEI prefix indication SEI message comprises the type value (e.g., the SEI message type of the NNPFC SEI message) and two prefixes of NNPFC SEI messages or alike, one containing the first identifier value and another containing the second identifier value. Furthermore, the decoder decodes from a processing order indication, such as from a SEI processing order SEI message, sets of a type value (e.g., the SEI message type of the NNPFC SEI message), a processing order value, and an index value indicating the prefix included in the SEI prefix indication SEI message or alike. The processing order values associated with the prefixes that contain the first or second identifiers indicate the respective processing order of the first filter and the second filter.

According to an embodiment, an encoder includes the type value (e.g., the SEI message type of the NNPFC SEI message) and the first identifier value as well as the type value (e.g., the SEI message type of the NNPFC SEI message) and the second identifier value in a processing order indication, such as in a SEI processing order SEI message, to indicate the respective processing order of the first filter and the second filter. In an embodiment, a decoder decodes the type value and the first identifier value as well as the type value and the second identifier value from a processing order indication, such as from a SEI processing order SEI message, to determine the respective processing order of the first filter and the second filter.

According to an embodiment, an encoder
indicates that a prefix of an SEI message or alike is included in a processing order indication, and
selects a number of heading bits of a neural network post-filter characteristics SEI message or alike such that a filter identifier value is included in the prefix.

For example, the following syntax and semantics or alike may be used:

| | Descriptor |
|---|---|
| sei_processing_order( payloadSize ) { | |
| i = 0 | |
| b = 0 | |
| do { | |
| po_sei_payload_type[ i ] | u(16) |
| po_sei_processing_order[ i ] | u(8) |
| b += 3 | |
| if( po_sei_payload_type[ i ] = = 201 ) { // SEI prefix indication | |
| SEI message | |
| po_prefix_sei_payload_type [ i ] | u(16) |
| po_num_bits_in_prefix_indication_minus1[ i ] | u(16) |
| for( j = 0; j <= | |
| po_num_bits_in_prefix_indication_minus1[ i ]; j++ ) | |
| po_sei_prefix_data_bit[ i ][ j ] | u(1) |
| while( !byte_aligned( ) ) | |
| po_byte_alignment_bit_equal_to_one /* equal to 1 */ | f(1) |
| b += (po_num_bits_in_prefix_indication_minus1[ i ] + 1 ) | |
| / 8 + | |
| (po_num_bits_in_prefix_indication_minus1[ i ] + 1 ) | |
| % 8 | |
| } | |
| i++ | |
| } while( b < payloadSize ) | |
| } | |

wherein

po_sei_payload_type[i] specifies, when not equal to 201, the value of payloadType for the i-th SEI message for which information is provided in the SEI processing order SEI message. The values of po_sei_payload_type[m] and po_sei_payload_type[n] shall not be identical unless m is equal to n or po_sei_payload_type[m] and po_sei_payload_type[n] are both equal to 201.

po_sei_processing_order[i] indicates the preferred order of processing any SEI message with payloadType equal to po_sei_payload_type[i] (this is not equal to 201) or po_prefix_sei_payload_type[i] (when po_sei_payload_type[i] is equal to 201).

po_prefix_sei_payload_type[i], when present, indicates the payloadType value for the i-th SEI message for which information is provided in the SEI processing order SEI message and for which the i-th SEI prefix indication is provided in the SEI processing order SEI message.

If po_sei_payload_type[i] is not equal to 201, poPayloadType[i] is set equal to po_sei_payload_type[i]. Otherwise, poPayloadType[i] is set equal to po_prefix_sei_payload_type[i].

po_sei_processing_order[m] greater than 0 and less than po_sei_processing_order[n] indicates any SEI message with payloadType equal to poPayloadType[m], when present, should be processed before any SEI message with payloadType equal to poPayloadType[n], when present. po_sei_processing_order[i] equal to 0 specifies that the preferred order of processing SEI messages with payloadType equal to poPayloadType[i] is unknown or unspecified or determined by external means. po_sei_processing_order[m] greater than 0 and equal to po_sei_processing_order[n] indicates that the m-th SEI message with payloadType equal to poPayloadType[m], when present, has the same input data as the n-th SEI message with payloadType equal to poPayloadType[n].

po_num_bits_in_prefix_indication_minus1[i] plus 1 specifies the number of bits in the i-th SEI prefix indication.

po_sei_prefix_data_bit[i][j] specifies the j-th bit of the i-th SEI prefix indication. The bits po_sei_prefix_data_bit[i][j] for j ranging from 0 to po_num_bits_in_prefix_indication_minus1[i], inclusive, follow the syntax of the SEI payload with payloadType equal to po_prefix_sei_payload_type[i], and contain a number of complete syntax elements starting from the first syntax element in the SEI payload syntax, and may or may not contain all the syntax elements in the SEI payload syntax. The last bit of these bits (i.e., the bit sei_prefix_data_bit[i][num_bits_in_prefix_indication_minus1[i]]) may be required to be the last bit of a syntax element in the SEI payload syntax.

byte_alignment_bit_equal_to_one may be required to be equal to 1.

In an embodiment for encoding or decoding, a type value in a processing order indication indicates an operation from a pre-defined set of operations. The pre-defined set of operations may comprise, but might not be limited to, one or more of the following:
Forking
Sample-wise combination with averaging
Sample-wise weighted combination
Sample-wise multiplicative weighting
Horizontal flipping (a.k.a. horizontal mirroring)
Vertical flipping (a.k.a. vertical mirroring)
Color space transformation
Resampling (wherein the target spatial resolution may be inferred or indicated)

In an embodiment for encoding order decoding, forking is specified to be an operation where multiple post-processing paths are created. In an example, all SEI messages or operations that have the same processing order value as the processing order value for the forking operation are processed in parallel (i.e., having the same input), as opposed to processing them as a sequence of operations or selecting one of them to be processed. In another example, all SEI messages or operations that have the same processing order value that is next higher than the processing order value for the forking operation are processed in parallel (i.e., having the same input). The forking may be subsequently followed by a sample-wise combination operation.

In an embodiment for encoding or decoding, the input sample arrays for an operation, such as a sample-wise combination operation, may be specified to be those sample arrays that result from the post-processing having the same highest value of processing order (e.g., po_sei_processing_order[i]) that is less than or equal to the processing order of the combination operation.

In an embodiment for encoding or decoding, a type value in a processing order indication indicates an operation from a pre-defined set of operations, when the type value is within a pre-defined value range. Otherwise, the type value may indicate a post-processing operation associated with an SEI message or alike. In an example, the following semantics may be used:

po_sei_payload_type[i] specifies, when in the range of 0 to 64511, inclusive, and not equal to 201, the value of payloadType for the i-th SEI message for which information is provided in the SEI processing order SEI message. The values of po_sei_payload_type[m] and po_sei_payload_type[n] shall not be identical unless m is equal to n or po_sei_payload_type[m] and po_sei_payload_type[n] are both equal to 201 or greater than 64511. The following values of po_sei_payload_type[i] specify a post-processing operation:
64512 specifies sample-wise combination with averaging po_sei_payload_type[i] values greater than 64512 are reserved.

In an embodiment for encoding or decoding, a processing order indication indicates an operation and parameter values for the operation. The parameter values may comprise, but might not be limited to, one or more of the following:
For sample-wise multiplicative weighting, the processing order indication may comprise a weight, indicating a multiplicative weight of the input sample array.
For sample-wise weighted combination, the processing order indication may comprise a number of weights, each indicating a multiplicative weight of the respective input sample array.
For color space transformation, the processing order indication may comprise an indication of the target color space.
For resampling, the processing order indication may comprise information indicative of the width and height (e.g., in luma samples) resulting from the resampling.

In an embodiment for encoding or decoding, a specific processing order value, such as zero, in a processing order indication indicates that the associated operation should be processed immediately after the previous operation in the order the operations or SEI messages are listed in the processing order indication. This enables treating two or more operations as a unit. Multiple such units can be performed in combination with a forking operation, and/or the result of multiple such units can be combined in a sample-wise combination process.

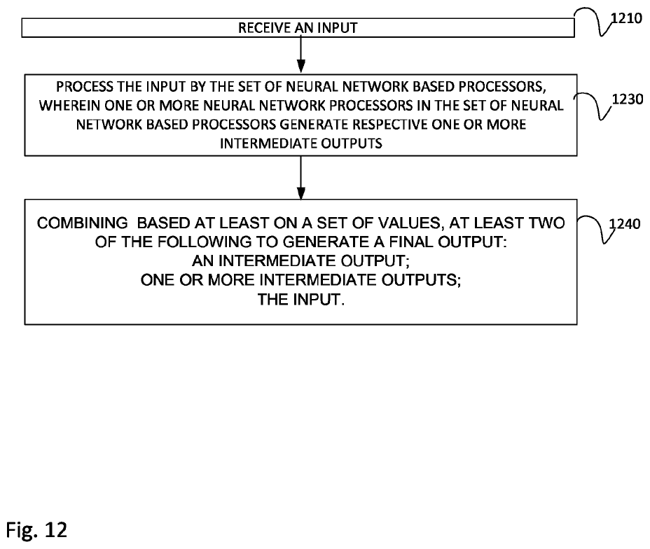

The method according to an embodiment is shown in FIG. 12. The method generally comprises receiving 1210 an input; processing 1230 the input by the set of neural network based processors, wherein one or more neural network based processors in the set of neural network based processors generate respective one or more intermediate outputs; and combining 1240, based at least on a set of values, at least two of the following to generate a final output: an intermediate output; one or more intermediate outputs; the input. Each of the steps can be implemented by a respective module of a computer system.

An apparatus according to an embodiment comprises means for receiving an input; means for processing the input by the set of neural network based processors, wherein one or more neural network based processors in the set of neural network based processors generate respective one or more intermediate output; and means for combining, based at least on a set of values, at least two of the following to generate a final output: an intermediate output; one or more intermediate outputs; the input. The means comprises at least one processor, and a memory including a computer program code, wherein the processor may further comprise processor circuitry. The memory and the computer program code are configured to, with the at least one processor, cause the apparatus to perform the method of FIG. 12 according to various embodiments.

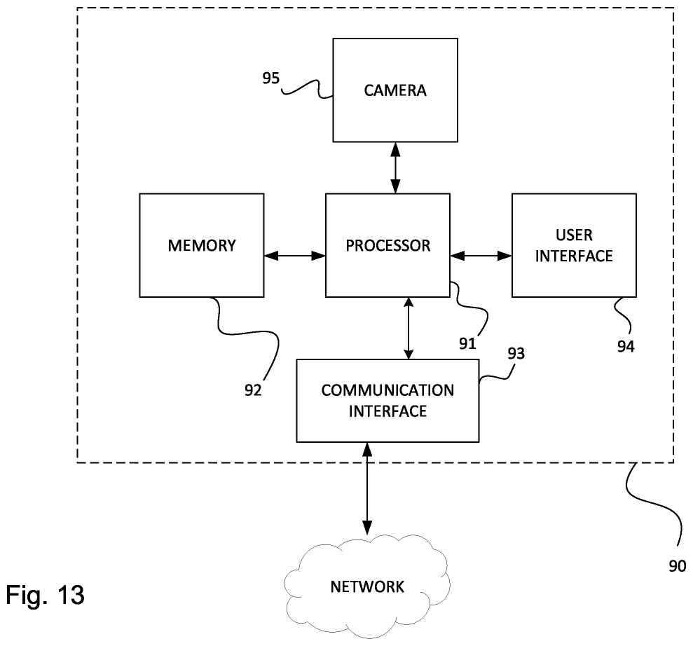

An example of an apparatus is shown in FIG. 13. The apparatus is a user equipment for the purposes of the present embodiments. The apparatus 90 comprises a main processing unit 91, a memory 92, a user interface 94, a communication interface 93. The apparatus according to an embodiment, shown in FIG. 13, may also comprise a camera module 95. Alternatively, the apparatus may be configured to receive image and/or video data from an external camera device over a communication network. The memory 92 stores data including computer program code in the apparatus 90. The computer program code is configured to implement the method according to various embodiments by means of various computer modules. The camera module 95 or the communication interface 93 receives data, in the form of images or video stream, to be processed by the processor 91. The communication interface 93 forwards processed data, i.e., the image file, for example to a display of another device, such a virtual reality headset. When the apparatus 90 is a video source comprising the camera module 95, user inputs may be received from the user interface.

Although some embodiments have been described with reference to specific syntax structures or syntax elements, embodiments apply to any similar syntax structures or syntax elements. For example, embodiments described with reference to an SEI message apply to any syntax structures for carriage of supplemental information, such as a metadata OBU.

The various embodiments can be implemented with the help of computer program code that resides in a memory and causes the relevant apparatuses to carry out the method. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of various embodiments.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1-14. (canceled)

15. An apparatus comprising: at least one processor; and at least one memory storing instructions that, when executed by the at least one processor, cause the apparatus at least to perform: receiving an input; processing the input by a set of neural network based processors, wherein one or more neural network based processors in the set of neural network based processors generate respective one or more intermediate outputs; and combining, based at least on a set of values, at least two of the following to generate a final output: an intermediate output; one or more intermediate outputs; the input.

16. The apparatus according to claim 15, wherein the one or more intermediate outputs are output by one neural network based processor.

17. The apparatus according to claim 16, wherein a first intermediate output is an output provided by the neural network based processor as a response to an input in its original form, and wherein any of one or more subsequent intermediate outputs is an output provided by the neural network based processor as a modified response to a modified input, where the modified input is obtained based on a modification operation applied to an input in its original form, and where the modified response is obtained based on an inverse modification operation applied to the output of the neural network based processor.

18. The apparatus according to claim 17 is further caused to perform: modifying an input by flipping the input data in horizontal direction, in vertical direction or in both directions, to obtain a flipped input, applying the neural network based processor to the flipped input to obtain an output, flipping back the output to obtain an intermediate output.

19. The apparatus according to claim 16 is further caused to perform: selecting an intermediate output from two or more intermediate outputs based at least on a selection flag, where the selection flag is provided in one of the following ways: signaled from an encoder to a decoder; is predefined for a decoder; is determined at a decoder side.

20. The apparatus according to claim 16, wherein a similarity score is determined based at least on the first intermediate output and on the one or more subsequent intermediate outputs.

21. The apparatus according to claim 15, wherein the neural network based processors comprise one or more components, whereupon internal data provided by said one or more components is used to generate the intermediate output.

22. The apparatus according to claim 15, wherein a neural network based processor comprises one or more components, wherein the apparatus is further caused to perform: removing or modifying different sets of connections between the components to obtain two or more versions of the neural network based processor.

23. The apparatus according to claim 15 is further caused to perform: weighting one or more intermediate outputs based at least on the set of values, where the set of values are determined based on one or more of the following: an indication for a set of predetermined weights, signaled from an encoder to a decoder; a weight update signaled from an encoder to a decoder; a set of weights, signaled from an encoder to a decoder; a set of weights, determined at decoder side.

24. The apparatus according to claim 15 is further caused to perform: receiving an indication of whether the combining should use predetermined weights, or signaled weights, or signaled weight updates, or weights determined at decoder side as a set of values.

25. The apparatus according to claim 20 is further caused to perform: determining at least one of the values in the set of values based on the similarity score between more than one intermediate output.

26. The apparatus according to claim 15 is further caused to perform: determining information concerning processing of the input by a set of neural network based processors, wherein the information concerning processing of the input by the set of neural network based processors comprises a processing order indication for any of the neural network based processors; an identifier value of any of the neural network based processors; a type value indicating an operation to be carried out by any of the neural network based processors.

27. The apparatus according to claim 26 is further caused to perform: determining a prefix of a Supplemental Enhancement Information (SEI) message in the processing order indication, wherein the prefix comprises a filter identifier value.

28. A method, comprising:
receiving an input;
processing the input by a set of neural network based processors, wherein one or more neural network based processors in the set of neural network based processors generate respective one or more intermediate outputs; and
combining, based at least on a set of values, at least two of the following to generate a final output: an intermediate output; one or more intermediate outputs; the input.

29. The method according to claim 28, wherein the one or more intermediate outputs are output by one neural network based processor.

30. The method according to claim 29, wherein a first intermediate output is an output provided by the neural network based processor as a response to an input in its original form, and wherein any of one or more subsequent intermediate outputs is an output provided by the neural network based processor as a modified response to a modified input, where the modified input is obtained based on a modification operation applied to an input in its original form, and where the modified response is obtained based on an inverse modification operation applied to the output of the neural network based processor.

31. The method according to claim 30, further comprising: modifying an input by flipping the input data in horizontal direction, in vertical direction or in both directions, to obtain a flipped input, applying the neural network based processor to the flipped input to obtain an output, flipping back the output to obtain an intermediate output.

32. The method according to claim 29, further comprising: selecting an intermediate output from two or more intermediate outputs based at least on a selection flag, where the selection flag is provided in one of the following ways: signaled from an encoder to a decoder; is predefined for a decoder; is determined at a decoder side.

33. The method according to claim 29, wherein a similarity score is determined based at least on the first intermediate output and on the one or more subsequent intermediate outputs.

34. The method according to claim 28, wherein the neural network based processors comprise one or more components, whereupon internal data provided by said one or more components is used to generate the intermediate output.
